(19) United States
(12) Patent Application Publication
(10) Pub. No.: US 2020/0389964 A1
(43) Pub. Date: Dec. 10, 2020

(54) INTELLIGENT LIGHT EMITTING MODULE

(71) Applicant: LEDLUCKY HOLDINGS COMPANY LTD., Shenzhen, Guangdong (CN)

(72) Inventor: Shaoqing LUO, Shenzhen (CN)

(73) Assignee: LEDLUCKY Holdings Company Ltd., Shenzhen, Guangdong (CN)

(21) Appl. No.: 16/469,235

(22) PCT Filed: May 18, 2018
(86) PCT No.: PCT/CN2018/087436

§ 371 Date: Jun. 13, 2019

(30) Foreign Application Priority Data
Mar. 26, 2018 (CN) 201810251106.7

(51) Int. Cl. H05B 47/19; H05B 45/10; H05B 45/20

(52) U.S. Cl. CPC H05B 47/19; H05B 45/20; H05B 45/10

(57) ABSTRACT

The present invention discloses an intelligent light emitting module, comprising a plurality of light emitting units and an intelligent device, wherein the intelligent device forms a wireless communications network with each of the light emitting units, the intelligent device sends a wireless communications signal carrying a control instruction to each of the light emitting units through the wireless communications network, and each of the light emitting units changes colors and/or luminance according to the corresponding control instruction in the wireless communications signal. In the intelligent light emitting module in the present invention, the intelligent device forms a wireless communications network with each of the light emitting units, so that the intelligent device sends the control instruction to each of the light emitting units through the wireless communications network, to control each of the light emitting units to change colors and/or luminance, thereby implementing secondary adjustment of the light emitting units.

This application claims priority to Chinese Patent Application No. 201810251106.7, filed with the Chinese Patent Office on Mar. 26, 2018 and entitled “intelligent light emitting module”, which is incorporated herein by reference in its entirety.

### TECHNICAL FIELD

The present invention relates to the field of LED lamp lighting technologies, and in particular, to an intelligent light emitting module.

### BACKGROUND

Currently, common lighting equipments on the market may form various forms of luminous characters or symbols, light emitting modules, jigsaws, chartlets, and the like. However, once these lighting equipments are produced, all states and functions thereof are determined, and users cannot perform secondary adjustment. There is no communication between the lighting equipments, and the lighting equipments cannot be controlled and adjusted by the users at will. Functions are few and monotonous.

In addition, the lighting equipments are powered by city power, and do not need to be powered through cables. Consequently, installation and use of the lighting equipments are complex, the installations costs are high, speeds are low, and installation places cannot be moved at will.

### SUMMARY

An objective of the present invention is to provide an intelligent light emitting module, to implement secondary adjustment of light emitting units.

To achieve the above objective, the present invention provides the following technical solution.

An intelligent light emitting module includes a plurality of light emitting units and an intelligent device, where the intelligent device forms a wireless communications network with each of the light emitting units, the intelligent device sends a wireless communications signal carrying a control instruction to each of the light emitting units through the wireless communications network, and each of the light emitting units changes colors and/or luminance according to the corresponding control instruction in the wireless communications signal.

Optionally, each of the light emitting units includes:

a wireless communications module, wirelessly connected to the intelligent device, and configured to receive a wireless communications signal sent by the intelligent device, and decode the wireless communications signal into a corresponding LED drive control signal;

an LED driver, connected to the wireless communications module, and configured to convert, according to the LED drive control signal, an operating current provided by a power module into a drive current, to drive a color and/or luminance of an LED bead to change;

the LED bead, connected to the LED driver, and configured to: display different colors and/or luminance by driving of the drive current; and

the power module, connected to the LED driver, and configured to provide the operating current for the LED driver.

Optionally, each of the light emitting units includes:

a unit housing, configured to accommodate the wireless communications module, the LED driver, and the power module, where the LED bead is disposed on a surface of the unit housing.

Optionally, the wireless communications module is a Bluetooth communications module and/or a Wi-Fi communications module.

Optionally, the power module is a battery.

Optionally, the intelligent device is a smartphone or a tablet computer.

According to specific embodiments provided in the present invention, the present invention discloses the following technical effects:

In the intelligent light emitting module in the present invention, an intelligent device forms a wireless communications network with each of the light emitting units, so that the intelligent device sends a control instruction to each of the light emitting units through the wireless communications network, to control each of the light emitting units to change colors and/or luminance, thereby implementing the secondary adjustment of the light emitting units.

### BRIEF DESCRIPTION OF THE DRAWINGS

The present invention will be explained in detail with reference to the accompanying drawings.

FIG. 1 is a schematic module structural diagram of an intelligent light emitting module according to an embodiment of the present invention.

FIG. 2 is a schematic module structural diagram of light emitting units in an intelligent light emitting module according to an embodiment of the present invention. Reference numeral description:

Light emitting unit 1, wireless communications module 11, LED drive 12, LED bead 13, power module 14, intelligent device 2

### DETAILED DESCRIPTION

The following describes in detail the technical solutions in the embodiments of the disclosure with reference to the accompanying drawings in the embodiments of the disclosure. Apparently, the described embodiments are merely a part rather than all of the embodiments of the disclosure. All other embodiments obtained by a person of ordinary skill in the art without creative efforts on the basis of the embodiments of the disclosure shall fall within the scope of protection of the disclosure.

An objective of the present invention is to provide an intelligent light emitting module. An intelligent device forms a wireless communications network with each of light emitting units, so that the intelligent device sends a control instruction to each of the light emitting units through the wireless communications network, to control each of the light emitting units to change colors and/or luminance, thereby implementing secondary adjustment of the light emitting units.

To make the foregoing objective, features, and advantages of the present invention clearer and more comprehensible, the present invention is further described in detail below with reference to the accompanying drawings and specific embodiments.

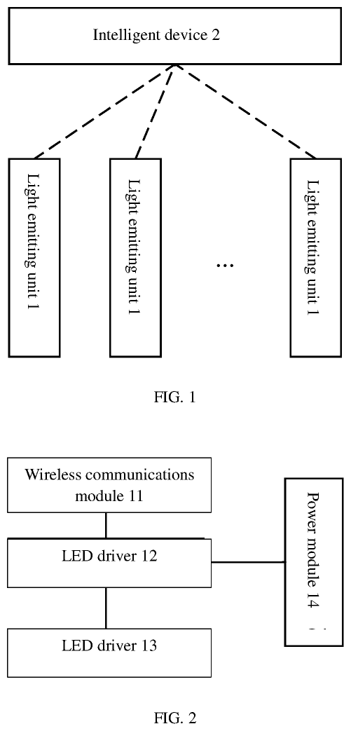

As shown in FIG. 1 (dashed lines represent communications connections), the intelligent light emitting module in the present invention includes a plurality of light emitting units 1 and an intelligent device 2, where the intelligent device 2 forms a wireless communications network with each of the light emitting units 1, the intelligent device 2 sends, through the wireless communications network, a wireless communications signal carrying a control instruction to each of the light emitting units 1, and each of the light emitting units 1 changes colors and/or luminance according to the corresponding control instruction in the wireless communications signal.

Specifically, as shown in FIG. 2, each of the light emitting units 1 includes a wireless communications module 11, an LED driver 12, an LED bead 13, and a power module 14.

The wireless communications module 11 is wirelessly connected to the intelligent device 2. The wireless communications module 11 is configured to receive a wireless communications signal sent by the intelligent device 2, and decode the wireless communications signal into a corresponding LED drive control signal. The wireless communications module 11 is a Bluetooth communications module and/or a Wi-Fi communications module.

The LED driver 12 is connected to the wireless communications module 11. The LED driver 12 is configured to convert, according to the LED drive control signal, an operating current provided by the power module into a drive current, to drive colors and/or luminance of the LED bead 13 to change.

The LED bead 13 is connected to the LED driver 12. The LED bead 13 is configured to display different colors and/or luminance by driving of the drive current.

The power module 14 is connected to the LED driver 12. The power module 14 is configured to provide the operating current for the LED driver 12. The power module 14 is a battery. Specifically, the battery may be a disposable battery or a rechargeable battery.

Specifically, the wireless communications module 11 receives the wireless communications signal sent by the intelligent device 2, and decodes the wireless communications signal into the LED drive control signal. The LED driver 12 has a control port, can receive the LED drive control signal, and convert, according to the LED drive control signal, the operating current provided by the power module 14 into different drive currents to drive the LED bead, so as to drive colors and/or luminance of the LED bead to change.

Preferably, each of the light emitting units 1 includes a unit housing; the unit housing is configured to accommodate the wireless communications module 11, the LED driver 12, and the power module 14; and the LED bead 13 is disposed on a surface of the unit housing.

The intelligent device 2 may be a smartphone or a tablet computer. Specifically, the intelligent device 2 may be an iOS\Android\WP system or another intelligent portable device or stationary device; and the intelligent device has a Bluetooth communications module and/or a Wi-Fi communications module, and is interconnected to the light emitting units 1 by using the Bluetooth communications module and/or the Wi-Fi communications module.

Further, an application (APP) may be installed on the intelligent device. The APP has a visible operation interface, and can implement a networking operation on the light emitting module, dimming or toning control, and a plurality of types of manual or automatic control, for example, can change colors and luminance of each module as music of a mobile phone changes.

In the intelligent light emitting module in the present invention, independent light emitting units are combined into a wireless communications network by using the Wi-Fi communications module or the Bluetooth communications module and a wireless control technology, and a functional APP is loaded by using an intelligent device such as a mobile phone or a tablet computer, to control the independent light emitting units. Next, each light emitting element can be placed at any place within coverage of a communications signal, and forms are flexible, which can bring stronger scene experience to users in occasions such as education, entertainment, and meetings. Moreover, the present invention can directly use conventional luminous characters, light emitting modules, jigsaws, and chartlets; and therefore, the production costs are low.

Each embodiment of the present specification is described in a progressive manner, each embodiment focuses on the difference from other embodiments, and the same and similar parts between the embodiments may refer to each other.

Several examples are used for illustration of the principles and implementation methods of the present invention. The description of the embodiments is used to help illustrate the method and its core principles of the present invention. In addition, those skilled in the art can make various modifications in terms of specific embodiments and scope of application in accordance with the teachings of the present invention. In conclusion, the content of this specification shall not be construed as a limitation to the invention.

1. An intelligent light emitting module, comprising a plurality of light emitting units and an intelligent device, wherein the intelligent device forms a wireless communications network with each of the light emitting units, the intelligent device sends a wireless communications signal carrying a control instruction to each of the light emitting units through the wireless communications network, and each of the light emitting units changes colors and/or luminance according to the corresponding control instruction in the wireless communications signal.

2. The intelligent light emitting module according to claim 1, wherein each of the light emitting units comprises:
a wireless communications module, wirelessly connected to the intelligent device, and configured to receive a wireless communications signal sent by the intelligent device, and decode the wireless communications signal into a corresponding LED drive control signal;
an LED driver, connected to the wireless communications module, and configured to convert, according to the LED drive control signal, an operating current provided by a power module into a drive current, to drive a color and/or luminance of an LED bead to change;
the LED bead, connected to the LED driver, and configured to: display different colors and/or luminance by driving of the drive current; and
the power module, connected to the LED driver, and configured to provide the operating current for the LED driver.

3. The intelligent light emitting module according to claim 2, wherein each of the light emitting units comprises:
a unit housing, configured to accommodate the wireless communications module, the LED driver, and the power module, wherein the LED bead is disposed on a surface of the unit housing.

4. The intelligent light emitting module according to claim 2, wherein the wireless communications module is a Bluetooth communications module and/or a Wi-Fi communications module.

5. The intelligent light emitting module according to claim 2, wherein the power module is a battery.

6. The intelligent light emitting module according to claim 1, wherein the intelligent device is a smartphone or a tablet computer.

7. The intelligent light emitting module according to claim 2, wherein the intelligent device is a smartphone or a tablet computer.

8. The intelligent light emitting module according to claim 3, wherein the intelligent device is a smartphone or a tablet computer.

9. The intelligent light emitting module according to claim 4, wherein the intelligent device is a smartphone or a tablet computer.

10. The intelligent light emitting module according to claim 5, wherein the intelligent device is a smartphone or a tablet computer.
